(19) United States
(12) Patent Application Publication
(10) Pub. No.: US 2005/0091079 A1
(43) Pub. Date: Apr. 28, 2005

(54) Method and system for early detection of disease

(76) Inventors: Patrick J. Kelly, New York, NY (US); Charles J. Conroy, New York, NY (US)

Correspondence Address: KRAMER LEVIN NAFTALIS & FRANKEL LLP;INTELLECTUAL PROPERTY DEPARTMENT, 919 THIRD AVENUE, NEW YORK, NY, 10022, US

(21) Appl. No.: 10/620,233

(22) Filed: Jul. 14, 2003

Related U.S. Application Data
(63) Continuation of application No. 09/384,895, filed on Aug. 27, 1999, now abandoned.

(51) Int. Cl. G06F 17/60

(52) U.S. Cl. 705/2; 705/3

(57) ABSTRACT

A method and system is provided wherein a user can access a scheduling service provider to arrange for a MRI-based health care screening appointment without a medical referral. After a user profile is completed and accepted by the scheduling service, an appointment for the MRI-based health care screening appointment, such as a magnetic resonance imaging scan of the user's brain, can be scheduled at participating health care screening facilities in the user's geographical area, the scheduling increasing the percentage utilization of the participating MRI-based health care screening facility and the availability of the health care screening procedure to the general public.

### FIELD OF THE INVENTION

The present invention relates to a method and system for the early detection of disease, more particularly a method and system for optimal utilization of magnetic resonance imaging equipment to provide early disease detection.

### BACKGROUND INFORMATION

Many individuals in the United States and throughout the world are needlessly dying from brain tumors and other abnormalities because these conditions, when eventually symptomatic, are diagnosed far too late to be curable by surgery or other therapies. This is because an exquisitely sensitive an accurate examination, such as magnetic resonance imaging (MRI) is not now widely available to the general public. This is for two major reasons: access; and cost. At the present time, these MRI studies are ordered only by a physician and only when indicated by specific symptoms. Secondly, diagnostic MRI is very expensive when obtained as an out-of pocket expense not covered by medical insurance.

However, an MRI examination can be abbreviated to significantly lower the cost. In addition, these low cost examinations can be used for the screening of the general, healthy and asymptomatic public in order to detect tumors and other pathology when these lesions are small, not yet malignant or life-threatening and potentially curable. For example, surgery, when and if necessary, can be done much less invasively and more safely on a small well localized lesion than as now performed after the tumor has enlarged and spread into important areas of the brain and causes symptoms. Under the present approach, however, surgery is frequently traumatic due to the advanced stage of the tumor or disease due to late diagnosis, particularly since once a brain tumor becomes malignant, it grows at a rate of 10% of its volume per week.

Unlike computed tomography (CT scanning) and other diagnostic and screening examinations which use x-ray and must, therefore, be ordered by a physician, MRI uses radio frequency and magnetic energy which does not requires a doctor's prescription. Nonetheless, MRI is the most sensitive examination for the detection of small lesions available at the present time. Thus, if more people had preliminary, ordinary brain scans before severe symptoms appear, death for the individual and trauma to the brain could be avoided.

### SUMMARY OF THE INVENTION

According to an exemplary embodiment of the present invention, a method and system are provided wherein a user can access a scheduling service provider and a screening MRI is arranged without a medical referral. After a user profile is completed and accepted by the scheduling service provider, an appointment for an MRI can be scheduled with a participating MRI facility or MRI screening center. Alternatively, low cost MRI screening units which can be conveniently located and available for the general public may be utilized. According to the present invention, the scheduling service provider can increase the percentage utilization of the existing MRI facilities and increase the availability of MRI scanning to the general public at a reduced cost.

### BRIEF DESCRIPTION OF THE DRAWING

FIG. 1 illustrates an exemplary method for health care screening according to an embodiment of the present invention.

FIG. 2 illustrates an exemplary method for processing a user request for health care screening according to an embodiment of the present invention.

FIG. 3 illustrates another exemplary method for processing a user request for health care screening according to an embodiment of the present invention.

FIG. 4 illustrates yet another exemplary method for processing a user request for health care screening according to an embodiment of the present invention.

FIG. 5 illustrates an exemplary system for health care screening according to an embodiment of the present invention.

FIGS. 6A-6D illustrate exemplary inquiries presented to a user desiring to schedule a health care screening procedure according to an embodiment of the present invention.

### DETAILED DESCRIPTION OF THE INVENTION

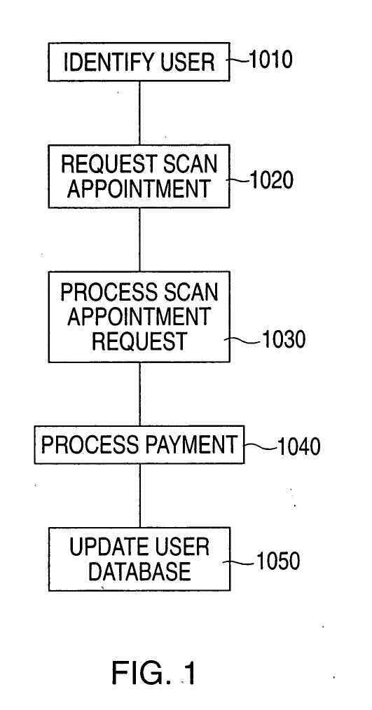

FIG. 1 illustrates an exemplary method for health care screening, such as a MRI-based health screening according to an embodiment of the present invention. In step 1010, a user is identified to, for example, a scheduling service provider for health care screening services, such as a scheduling service for MRI scans of the brain. For example, the user could access the scheduling service provider using conventional methods such as via mail, a public computer network (e.g., the Internet), a telephone connection or other suitable connection means. In step 1020, the user requests a scan appointment. For example, the user can specify a convenient geographical location for the scan and suitable times for the appointment.

In step 1030, the request for scan appointment is processed by the scheduling service provider. For example, the request could be processed manually using a scheduling calendar for the desired geographical location to determine if an appointment can be made. In a computerized system, a database system of the scheduling service provider, such as a conventional relational database or software program, such as MICROSOFT ACCESS, could be accessed to schedule the scan appointment. In step 1040 the user provides for payment for the scan using, for example, a credit card or other suitable form of payment and the scheduling service provider processes the payment. In step 1050, a user database maintained by the scheduling service provider, whether manually or computer-based, is updated based on the information provided by the user. For example, the scheduling service provider may retain each user's personal and medical information. In addition, after the scan is completed, the results of the scan (e.g., normal or abnormal) as well as the scan itself, may be stored in the user database. In exemplary embodiments, the results of the scan can be transmitted to the user via facsimile or e-mail, including a digital image of the scan transmitted electronically.

According to an exemplary embodiment of the present invention, the consolidation of unused capacity of diagnostic MRI facilities for utilization by the general public and changing the procedural paradigms for screening (e.g., screening rather than diagnostic purposes) creates economics of scale by significantly reducing scanning time and maximizing throughput such that the cost of a screening examination can be greatly reduced compared to current costs of diagnostic examinations. This can reduce the cost of the screening scan according to an embodiment of the present invention to 10%-15% of the cost of a diagnostic MRI. For example, a screening MRI procedure (e.g., a Type 2 scan) can be performed in approximately three to five minutes, compared with one hour or longer to perform a diagnostic MRI procedure. The T2 scan can detect, however, abnormalities as small as 5 mm in diameter.

Thus, screening can be made available to a much greater proportion of the general population which at the present time has a very limited access. Moreover, the value of the screening scan will be much greater in asymptomatic people as the early detection of pathology in these individuals has a better chance of actually leading to a potentially curative procedure.

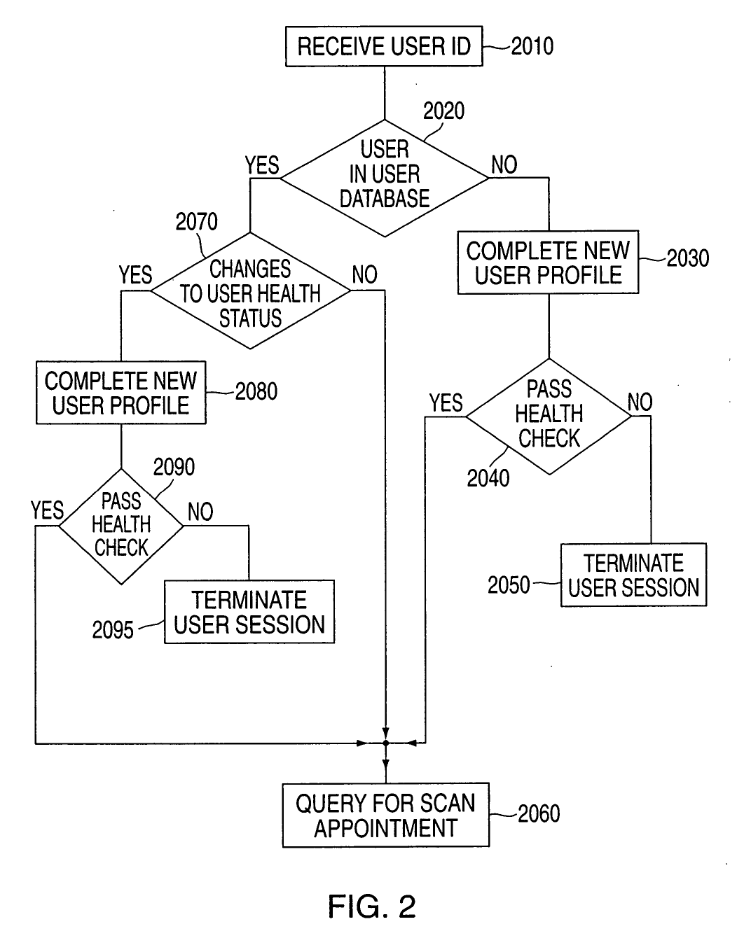

FIG. 2 illustrates an exemplary method for processing a user request for health care screening according to an embodiment of the present invention. For example, the step of identifying a user may include the following. In step 2010, a user identification is received by the scheduling service provider. For example, a user could connect to an Internet web site of a scheduling service provider using a conventional desktop or laptop computer. Upon connecting to the scheduling service provider's website, the user could navigate a series of screens or hyperlinks presented by the host web site for users interested in scheduling, for example, a brain scan. The user can be asked to enter a user identification and password (e.g., if already registered with the service provider) or merely provide a full name and/or address. In step 2020, it is determined if the user is already registered with the scheduling service provider.

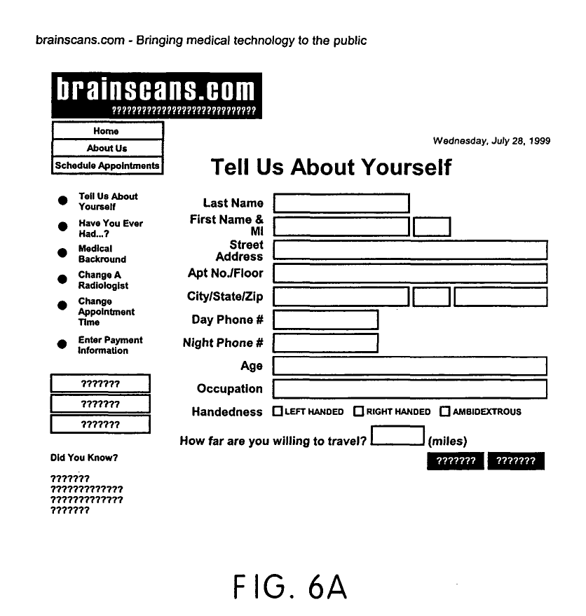

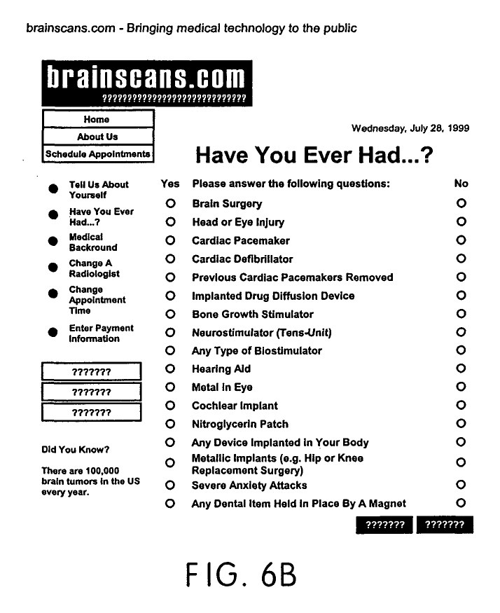

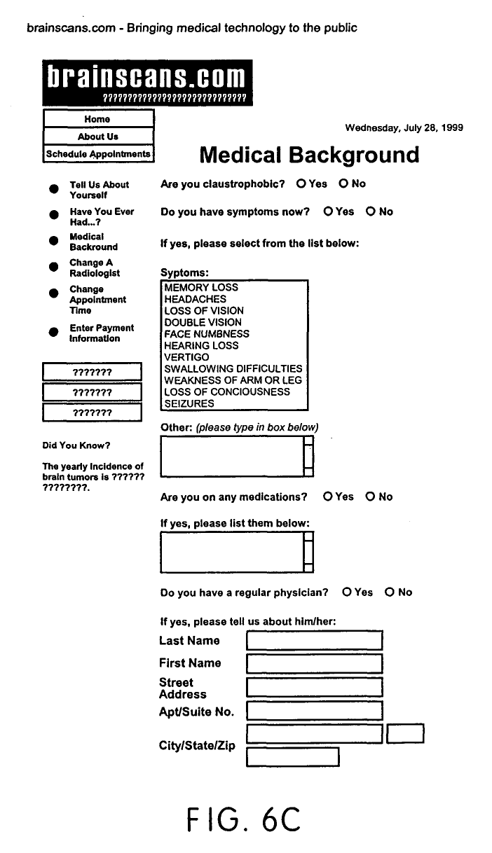

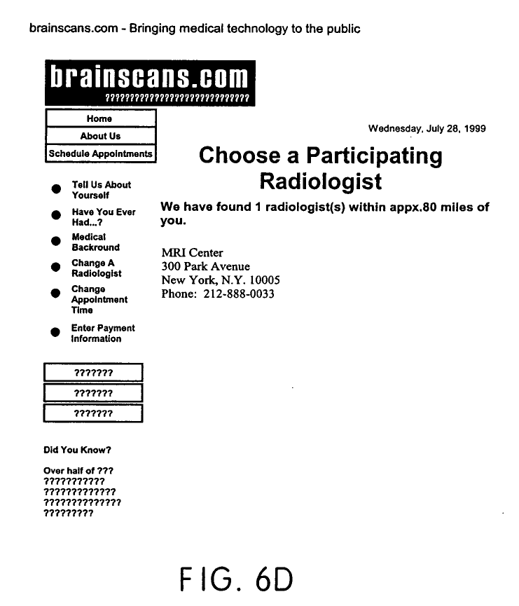

If the user is not registered with the scheduling service provider, then in step 2030, the user can be prompted, for example, to complete a user profile or questionnaire prepared by the scheduling service provider. The user profile may include relevant identification information about the user, such as age and sex as well as pertinent health information. FIG. 6A illustrates an exemplary inquiry screen to obtain information on a user. Medical history questions appropriate for the type of MRI-based health care screening procedure being requested also can be presented to the user. FIGS. 6B and 6C illustrate exemplary medical questions that can be presented to a user. Based on the response to the medical questions, the scheduling service provider can determine if the user is authorized to receive the requested procedure. For example, a health history of cardiac pacemaker or a surgically implanted foreign metallic body would preclude a user from going forward in the scheduling procedure and would be unable to obtain an MRI examination which would, in these circumstances, be contraindicated. If the user fails the health check at step 2040, then the user's request for a health care screening procedure is terminated. If the user passes the health check at step 2040, then the user is queried to request a scan appointment at step 2060.

If the user is already registered in the scheduling service provider's database at step 2020, then at step 2070, the user is queried whether any changes to the user's health status have occurred that would alter the user's health profile. In an exemplary embodiment of the present invention, the scheduling service provider may provide a screen to the user showing the current health information on file for the user and ask the user to verify the information. If there are no changes to the user's health status, then the process continues to step 2060. If there is a change to the user's health status, however, then the user would be requested to complete a new or updated user profile in step 2080. If the updated user profile passes the scheduling service provider's health check in step 2090, then the process continues at step 2060. If the user fails the health check at step 2090, however, then the user's request for a health care screening is terminated.

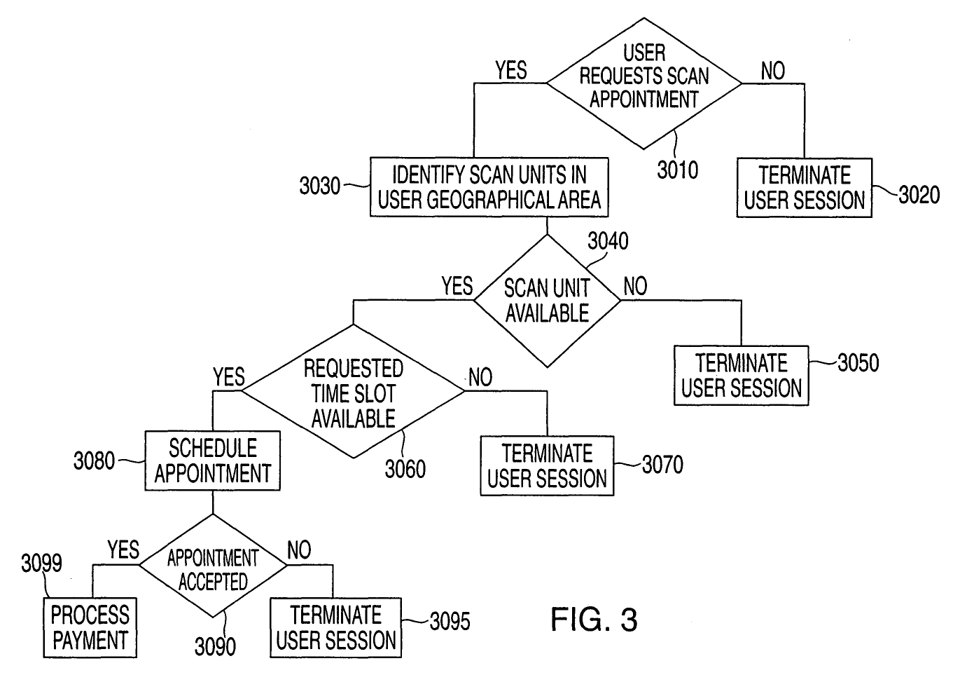

FIG. 3 illustrates the scheduling of a scan appointment request according to an exemplary embodiment of the present invention. If a user is accepted by the scheduling service provider (e.g., passes the health check) and desires MRI-based health care screening, in step 3010 the user requests a scan appointment. For example, the user may verbally request an appointment to an operator or the user could click on an appropriate icon or hyperlink on a screen of a web page. If no appointment is requested, the user's request for MRI-based health care screening is terminated in step 3020. If an appointment is requested in step 3010, the scheduling service provider identifies the MRI-based health care screening facilities available for the requested procedure in step 3030. For example, for a brain scan, the scheduling service provider would identify the available MRI machines available in the geographical area requested by the user on the requested dates. The identifying information already provided by the user can be used to facilitate the matching process. If desired by the scheduling service provider, several choices can be presented to the user for health care screening facilities in varying locations.

In step 3040, the scheduling service provider determines if a scan unit is available. If not, then the user's health care screening request is terminated or another date and location are requested from the user. If a scan unit is available, in step 3060 the scheduling service provider determines if the time slot requested by the user is available or if there is an available time that presents the closest possible match between time slots requested by the user and available time slots of the health care screening facility. The user is then asked if this time and scanning facility is acceptable. If not, the user is presented with a list of MRI facilities and may select one of these and an acceptable time slot within the schedule posted for the alternate facility. FIG. 6D illustrates an exemplary screen for selecting a MRI-based health care screening facility that would be presented to a user.

If a suitable time slot is available, then an appointment is scheduled at step 3080. If the appointment is accepted by the user in step 3090, then the user arranges for payment for the MRI-based health care screening which is processed by the scheduling service provider in step 3099. For example, the user can arrange for payment by credit card or debit card to the scheduling service provider, who can share the fee with the health care screening facility on a mutually agreeable basis. If the appointment is not accepted by the user, then the user's request for a health care screening is terminated in step 3095.

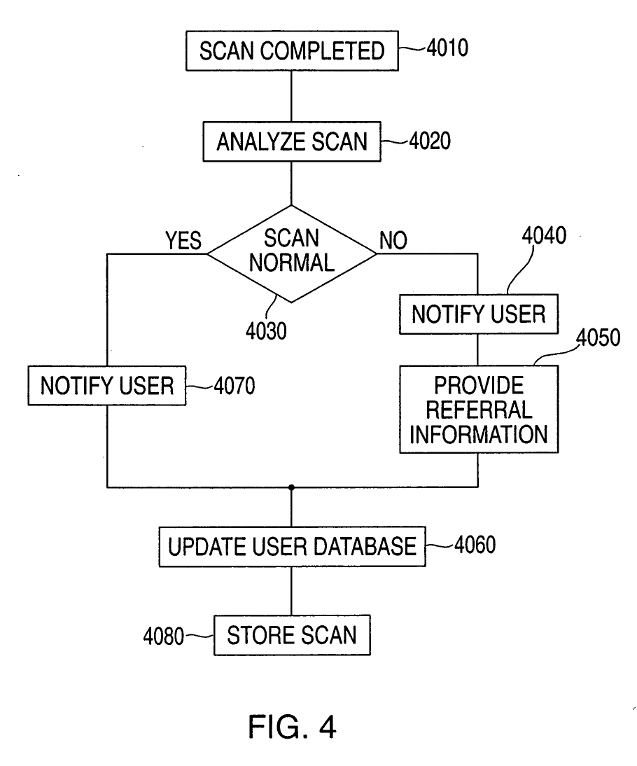

FIG. 4 illustrates an exemplary method for processing a MRI-based health care screening appointment according to an embodiment of the present invention. For example, when the MRI-based health care screening appointment is completed in step 4010, such as a brain scan being completed, the scan result is analyzed by a qualified professional in step 4020, such as a radiologist affiliated with the health care screening facility. As a result of the review by the qualified professional in step 4020, at step 4030 it is determined if the scan result is normal. If normal, the user is notified in step 4070. If not normal, the user is also notified in step 4040 and referral information and additional relevant medical literature is provided in step 4050. At step 4060, the scan result is entered into the user's profile in the records of the scheduling service provider. In an exemplary embodiment of the present invention, a copy of the scan results, such as a digitized copy of the MRI image, can be stored in the scheduling service provider's database in step 4080. For example, the copy would then be available for subsequent review by others as requested by the user whenever needed.

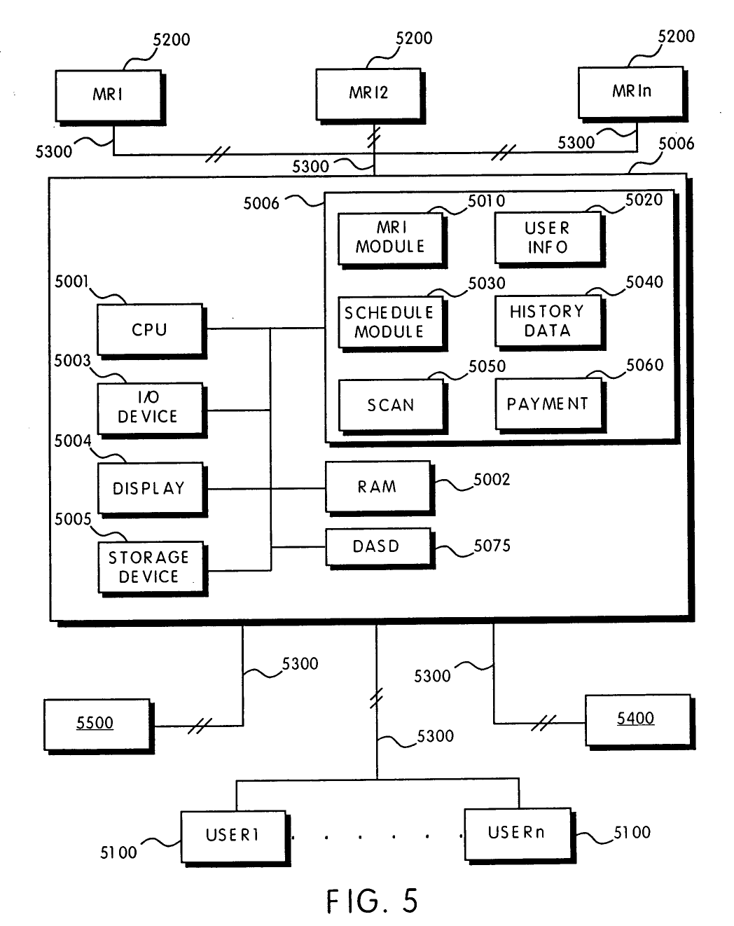

FIG. 5 illustrates an exemplary system for MRI-based health care screening according to an embodiment of the present invention. The exemplary system includes, for example, a computer system 5000 maintained by the scheduling service provider. The computer system 5000 could be, for example, a microprocessor based server such as a SUN WORKSTATION or WINDOWS NT server or other computer system having suitable processing power and storage. Computer 5000 includes, for example, a central processing unit 5001, random access memory 5002, input/output device(s) 5003 and display 5004 coupled via a conventional bus 5005. Also coupled to bus 5005 is a storage device 5006 such as a hard disk drive. Storage device 5006 could include, for example, various modules necessary to carry out the method according to an exemplary embodiment of the present invention.

As illustrated in FIG. 5, computer system 5000 may include, for example, a MRI module 5010, a user information module 5020, a scheduling module 5030, a historical data module 5040, a scan module 5050 and a payment module 5060. Attached to computer 5000 could be a direct access storage device (DASD) 5075 to store, for example, various modules such as the user information module 5020, the scan module 5050 and the MRI module 5010 or other data as needed, particularly for a database implementation of the present invention that requires substantial storage space.

Coupled to computer 5000 are one or more MRI-based health care screening facilities 5200. For example, each MRI-based health care screening facility 5200 can be a MRI scanning facility affiliated with the scheduling service provider. Each facility 5200 can be connected to computer 5000 via communications link 5300 such as a proprietary dial-up connection (e.g., a LAN or WAN) or a public connection such as the Internet. Also coupled to computer 5000 are third party entities 5400, 5500. Third party entities 5400, 5500 may include, for example, payment processing facilities, e.g., VISA and MASTERCARD processing centers, or medical facilities that may need access to scan data maintained by the scheduling service provider. Also coupled to computer 5000 are users 5100 who desire to schedule health care screening appointments through the scheduling service. Connections to computer 5000 are via, for example, communications link 5300 which may include a proprietary dial-up connection, a wireless connection or a public network connection such as the Internet.

As mentioned with respect to FIGS. 1-4, software stored in random access memory 5002 and modules 5010-5060 carry out the exemplary method for MRI-based health care screening according to an embodiment of the present invention. In an exemplary embodiment of the present invention, software stored in memory 5002 is executed by the central processing unit 5001 of computer 5000. The software stored in storage 5002 can interact with the modules 5010-5060. For example, MRI module 5010 could store information on the MRI scanning facilities affiliated with the scheduling service provider. The MRI module information could include, for example, the location and available hours of the MRI equipment at each facility as well as if there are multiple machines at each facility and the type of available equipment. For example, some facilities may have open MRI equipment requested by certain users of the scheduling service. User information module 5020 can store the personal information provided by each user registering with the scheduling service provider as well as the preferred geographical locations and time preferences for a health care screening appointment from each user. MRI module 5010 and user information module 5020 may be implemented, for example, using a relational database system such as DB2 by International Business Machines of New York.

Scheduling module 5030 provides for the scheduling of health care screening appointments. For example, using the data from MRI module 5010 and user information module 5020, scheduling module 5030 can optimally match the availability of health care screening facilities and requests for appointments. Conventional scheduling and load balancing software, such as COLD FUSION and MICROSOFT ACCESS, may be used to implement scheduling module 5030. Through the matching of underutilized MRI-based health care screening facilities and requests for MRI-based health care screening appointments, previously underutilized equipment, such as multimillion dollar MRI machines, can be optimally operated.

As a result, additional revenue can be generated by the operator of the underutilized equipment. In addition, the additional volume of users of the health care screening facility and reduced scope of examination (e.g., screening versus diagnostic) can reduce the cost of testing to users, thereby making a procedure available to the general public that without the present invention was generally unavailable to the public unless potentially deadly health symptoms had already arisen. With respect to abnormalities of the brain, the onset of symptoms that would lead to a detailed evaluation often arise too late for meaningful medical treatment, but such early detection could be widely available according to an exemplary embodiment of the present invention.

Historical data module 5040 may store essential elements of the users medical history. Scan module 5050 may be optionally used by the scheduling service provider to store the scan data, such as a digitized MRI image for subsequent use on behalf of the user, for example for review by a personal physician of the user. Payment module 5060 provides, for example, for the conventional processing of payments from the user for utilizing the scheduling service.

Although the above examples relate to health care screening scans for the brain using MRI imaging technology, the system and method according to the present invention can be used with respect to other parts of the body and other types of MRI-based health care screening technology. For example, the method and system applies not only to screening brain MRI scans but also to screening MRI scans of the entire body by contracted diagnostic MRI units or by MRI units which have been developed for the sole purpose of low cost screening examinations.

Finally, a purpose built MRI screening unit which could be located at public gathering places such as malls, airports, etc. also are within the scope of the method and system according to an embodiment of the present invention. Such an alternative could include, for example, a purpose built MRI unit (e.g., for screening procedures instead of diagnostic purposes), a metal detection alarm, an interactive screening history questionnaire, a credit card scanning unit, an Internet connection for billing and data acquisition, an on-board or networked computer program which would compare each scan to a normative database and an output method which would inform the user of the results of the scan.

1. A method for health care screening, comprising:
contacting a scheduling service;
scheduling an abbreviated MRI procedure designed for an asymptomatic individual via the scheduling service;
determining if the abbreviated MRI procedure can be authorized; and
scheduling the abbreviated MRI procedure;
wherein the scheduling includes selecting a location and an unused time slot for the abbreviated MRI procedure available between scheduled diagnostic MRI procedures at one of a predetermined set of existing procedure facilities affiliated with the scheduling service as a function of location and time parameters of a user and an availability of the predetermined set of procedure facilities.

2. The method according to claim 1, wherein the abbreviated MRI procedure designed for an asymptomatic individual includes a T2 type MRI scan.

3. The method according to claim 1, wherein the abbreviated MRI procedure designed for an asymptomatic individual is to be performed on a brain of the user of the scheduling service.

4. The method according to claim 1, wherein the contacting includes a computer network connection of the user to the scheduling service.

5. The method according to claim 1, further comprising determining a result of the abbreviated MRI procedure designed for an asymptomatic individual.

6. The method according to claim 5, wherein the result is determined by a radiologist associated with the procedure facility performing the abbreviated MRI procedure designed for an asymptomatic individual.

7. The method according to claim 6, further comprising storing the result by the scheduling service.

8. The method according to claim 2, wherein the predetermined set of existing procedure facilities include a set of existing MRI facilities.

9. The method according to claim 2, wherein the contacting includes contacting the scheduling service via one of a computer network connection and a voice connection.

10. The method according to claim 9, wherein the computer network connection includes an Internet connection via a web browser.

11. The method according to claim 10, wherein the determining includes presenting at least one web page screen to the user requesting predetermined user personal and medical information.

12. The method according to claim 11, wherein determining if the abbreviated MRI procedure can be authorized is performed as a function of the user's predetermined user personal and medical information.

13. A system for health care screening, comprising:
a central processing unit; and
a memory coupled to the central processing unit; wherein
computer program means stored in the memory are executed by the central processing unit, the executed computer program means
receiving a request for an abbreviated MRI-based health care screening procedure designed for an asymptomatic individual,
determining if the abbreviated MRI-based health care screening procedure can be authorized, and
scheduling the abbreviated MRI-based health care screening procedure, wherein the scheduling includes selecting a location and an unused time slot for the health care screening procedure available between scheduled diagnostic MRI procedures at one of a predetermined set of existing procedure facilities affiliated with the scheduling service as a function of location and time parameters of a user and an availability of the predetermined set of procedure facilities.

14. The system according to claim 13, wherein the receiving includes receiving a request via a computer network connection of the user to the scheduling service.

15. The system according to claim 14, wherein the computer network connection includes an Internet connection via a web browser.

16. The system according to claim 14, wherein the determining includes presenting at least one web page screen to the user requesting predetermined user personal and medical information.

17. The method according to claim 16, wherein determining if the abbreviated MRI-based health care screening procedure can be authorized is performed as a function of the user's predetermined personal and medical information.

18. The system according to claim 13, wherein the abbreviated MRI-based health care screening procedure includes a T2 type MRI scan.

19. The system according to claim 18, wherein the abbreviated MRI-based health care screening procedure is performed on a brain of a user.

20. An article of manufacture, comprising:
a computer usable medium having computer readable code means embodied therein for causing a scheduling of an abbreviated MRI-based health care screening procedure designed for an asymptomatic individual, the computer readable program code means in said article of manufacture including
computer readable program means for causing a computer to receive a request for the abbreviated MRI-based health care screening procedure designed for an asymptomatic individual,
computer readable program means for causing the computer to determine if the abbreviated MRI-based health care screening procedure can be authorized, and
computer readable program means for causing the computer to schedule the abbreviated MRI-based health care screening procedure, wherein the scheduling includes selecting a location and an unused time slot for the health care screening procedure available between scheduled diagnostic MRI procedures at one of a predetermined set of existing procedure facilities affiliated with the scheduling service as a function of location and time parameters of a user and an availability of the predetermined set of procedure facilities.
